(19) United States
(12) Patent Application Publication
(10) Pub. No.: US 2026/0042148 A1
(43) Pub. Date: Feb. 12, 2026

(54) METHOD FOR PREPARING MAGNESIUM ALLOY TISSUE ENGINEERING SCAFFOLD WITH SMOOTH INNER SURFACE BY LASER POWDER BED FUSION (LPBF)

(71) Applicant: SHANGHAI JIAO TONG UNIVERSITY, Shanghai (CN)

(72) Inventors: Guangyin YUAN, Shanghai (CN); Bozun MIAO, Shanghai (CN); Penghuai FU, Shanghai (CN)

(73) Assignee: SHANGHAI JIAO TONG UNIVERSITY, Shanghai (CN)

(21) Appl. No.: 19/298,293

(22) Filed: Aug. 13, 2025

Related U.S. Application Data
(63) Continuation of application No. PCT/CN2025/095138, filed on May 15, 2025.

(30) Foreign Application Priority Data
Aug. 6, 2024 (CN) 202411071907.7

(51) Int. Cl. B22F 10/85; B22F 10/28; B22F 10/366; B33Y 10/00; B33Y 50/02; B33Y 80/00

(52) U.S. Cl. CPC B22F 10/85; B22F 10/28; B22F 10/366; B33Y 10/00; B33Y 50/02; B33Y 80/00; B22F 2301/058; B22F 2998/10

(57) ABSTRACT

A method for preparing a magnesium alloy tissue engineering scaffold with a smooth inner surface by laser powder bed fusion (LPBF) is provided. The method includes: step S1: scanning a porous scaffold, and selecting the densest filling scan parameters, where the scanning includes a single-pass contour scan and a single-pass filling scan; step S2: optimizing a contour scan strategy according to the densest filling scan parameters; step S3: acquiring a corresponding melt pool dimension, and adjusting a spot compensation value based on the optimized contour scan strategy; and step S4: preparing a magnesium alloy tissue engineering scaffold based on the contour scan strategy and the adjusted spot compensation value. The method eliminates powder adhesion and sagging defects inside the complex porous structure that severely affect inner surface roughness and scaffold performance, thereby the pore connection, fatigue and corrosion resistance will be improved greatly.

### CROSS REFERENCE TO THE RELATED APPLICATIONS

This application is a continuation application of International Application No. PCT/CN2025/095138, filed on May 15, 2025, which is based upon and claims priority to Chinese Patent Application No. 202411071907.7, filed on Aug. 6, 2024, the entire contents of which are incorporated herein by reference.

### TECHNICAL FIELD

The present disclosure relates to the technical field of biomedical material preparation, and in particular to a method for preparing a magnesium alloy tissue engineering scaffold with a smooth inner surface by laser powder bed fusion (LPBF).

### BACKGROUND

1. Large-segment bone defects with a length exceeding 2-2.5 times the diameter of the defective bone caused by trauma, disease, developmental deformities, revision surgery, tumor resection, or osteomyelitis are one of the major challenges in clinical orthopaedics. The ideal bone scaffold must possess sufficient mechanical strength, corrosion resistance, and biocompatibility to fulfill its load-bearing function. Meanwhile, the scaffold must have an interconnected porous network to transport nutrients and allow cell migration. Among various additive manufacturing (AM) technologies, laser powder bed fusion (LPBF) has advantages such as high structural design freedom, high preparation accuracy, short development cycle, and avoidance of subsequent machining processes. Therefore, LPBF is widely applied to the fabrication of bone tissue engineering scaffolds. LPBF magnesium alloy tissue engineering scaffolds are artificially manufacturable, low-cost, and free of immune rejection compared to autologous or allogeneic bone graft scaffolds and have high biocompatibility, high osteogenic induction performance, and high mechanical strength compared to polymer scaffolds. Therefore, LPBF magnesium alloy tissue engineering scaffolds have received widespread attention in recent years. However, due to their low boiling point and high vapor pressure, magnesium alloys exhibit severe powder evaporation and spattering during the three-dimensional (3D) printing process. Additionally, the low melting point, high thermal conductivity, and low surface tension of magnesium can easily cause large melt pools and heat-affected zones, making the surface and interior of porous scaffolds extremely susceptible to adhering large amounts of unmelted powder, thereby forming powder adhesion defects. After the laser melts the powder, the melt infiltrates the powder below the horizontal overhangs inside the scaffold under gravitational and capillary forces. Consequently, a large amount of powder adheres to the lower surface of the overhang, thereby forming sagging defects.

2. Powder adhesion and sagging inside the scaffold degrade the permeability, fatigue performance, and corrosion performance of the porous scaffold. For scaffolds with smaller pore sizes, the powder adhered to the inner surface of the scaffold obstructs the ingress of the external polishing medium, making the fluid flow increasingly restricted toward the core of the scaffold. In contrast, larger scaffold dimensions significantly elevate the difficulty of inner surface polishing. In severe cases, detached powder particles mechanically interlock with the adhered powder, completely occluding internal pores and compromising the scaffold's 3D interconnectivity. Besides, after being implanted into the human body, the porous scaffold needs to undergo cyclic loading. However, the powder adhesion markedly elevates the surface roughness of the scaffold. This not only promotes the initiation of surface fatigue cracks but also expands the contact area between the scaffold and corrosive media, drastically accelerating scaffold corrosion. Consequently, substantial hydrogen gas generation occurs, thereby leading to gas accumulation at the implantation site.

3. To improve surface smoothness, porous scaffolds often undergo post-processing techniques such as chemical or electrochemical polishing. However, magnesium alloys will generate large amounts of hydrogen gas in acidic polishing solutions, severely impeding the penetration of the polishing solution into the interior of the scaffold. Consequently, while the exterior struts of the scaffold are easily polished to the target strut diameter, the interior struts of the scaffold resist adequate polishing, resulting in thinner edge struts and thicker interior struts. The discrepancy between the interior and exterior strut diameter intensifies with larger scaffold dimensions, smaller pore sizes, and reduced structural permeability (i.e. the ease of fluid flow through the porous medium). Therefore, there is an urgent need for a forming method that can effectively reduce internal powder adhesion and sagging defects in LPBF magnesium alloy porous scaffolds to improve their corrosion resistance and corrosion fatigue performance.

### SUMMARY

In view of the defects in the prior art, an objective of the present disclosure is to provide a method for preparing a magnesium alloy tissue engineering scaffold with a smooth inner surface by laser powder bed fusion (LPBF).

In the present disclosure, the method for preparing a magnesium alloy tissue engineering scaffold with a smooth inner surface by LPBF includes:
step S1: scanning a porous scaffold, and selecting densest filling scan parameters;
where, the scanning includes a single-pass contour scan and a single-pass filling scan;
step S2: optimizing a contour scan strategy according to the densest filling scan parameters;
step S3: acquiring a corresponding melt pool dimension, and adjusting a spot compensation value based on the optimized contour scan strategy; and
step S4: preparing a magnesium alloy tissue engineering scaffold based on the contour scan strategy and the adjusted spot compensation value.

Preferably, the step S1 includes:
performing the single-pass contour scan and the single-pass filling scan on the porous scaffold, with contour scan parameters consistent with filling scan parameters; cutting an as-built specimen along a direction parallel to a build direction (BD); polishing a cross-section, acquiring an optical micrograph of the cross-section, and analyzing a density of the cross-section; and selecting parameters P_{filling} and V_{filling} satisfying 0.05≤P/V≤0.5 from a parameter combination corresponding to a density of greater than 99.5%;
where, P denotes a laser power, and V denotes a scan speed.

Preferably, the step S2 includes:
setting the filling scan parameters as P_{filling} and V_{filling}, the contour scan parameters as P_{contour} and V_{contour}, and a number of contour scans as PT; and calculating a contour parameter as follows:

$$\frac{{P}_{contour}}{{V}_{contour}} = \frac{{P}_{filling}}{{V}_{filling}} * ( 1 - \frac{PT}{Z} )$$

where, Z denotes a contour line energy density scaling coefficient, Z=5 to 30; within a range of a contour compensation value PC, a plurality of pre-contour scans and a plurality of post-contour scans are performed, from an inner contour scan to an outer contour scan or from an outer contour scan to an inner contour scan in terms of scan sequence; the pre-contour scans and the post-contour scans are performed by taking different values of following parameters: laser power P, scan speed V, number of contour scans PT, contour line energy density scaling coefficient Z, and contour compensation value PC; and a filling compensation value FC ranges within 0≤FC≤PC.

Preferably, the step S3 includes:
acquiring a melt pool width corresponding to a structure and a process parameter, and optimizing the spot compensation value;
denoting a wall thickness/strut diameter of an original design scaffold model as T₀ and a wall thickness/strut diameter acquired by using the optimized contour scan strategy as T₁, and calculating the spot compensation value as follows:

$$SC = \frac{( {T}_{1} - {T}_{0} ) * SZ}{2 {R}_{melt}}$$

where, SZ denotes a spot diameter; Rₘₑₗₜ denotes the melt pool width corresponding to P_{filling}/V_{filling}; and the spot compensation value is adjustable to compensate for a dimensional increase caused by a plurality of contour scans.

Preferably, the step S1 further includes: setting, before the filling scan is performed, the plurality of pre-contour scans with a predetermined energy density according to a specific scaffold structure and a length of a lower surface overhanging region; and setting, after the filling scan is completed, the plurality of post-contour scans with a predetermined energy density according to a specific surface powder adhesion condition of the scaffold.

In the present disclosure, the method for preparing a magnesium alloy tissue engineering scaffold with a smooth inner surface by LPBF includes:
a module M1, configured to scan a porous scaffold and select densest filling scan parameters;
where, the scan includes a single-pass contour scan and a single-pass filling scan;
a module M2, configured to optimize a contour scan strategy according to the densest filling scan parameters;
a module M3, configured to acquire a corresponding melt pool dimension and adjust a spot compensation value based on the optimized contour scan strategy; and
a module M4, configured to prepare a magnesium alloy tissue engineering scaffold based on the contour scan strategy and the adjusted spot compensation value.

Preferably, the module M1 is configured to perform following steps:
performing the single-pass contour scan and the single-pass filling scan on the porous scaffold, with contour scan parameters consistent with filling scan parameters; cutting an as-built specimen along a direction parallel to a BD; polishing a cross-section, acquiring an optical micrograph of the cross-section, and analyzing a density of the cross-section; and selecting parameters P_{filling} and V_{filling} satisfying 0.05≤P/V≤0.5 from a parameter combination corresponding to a density of greater than 99.5%;
where, P denotes a laser power, and V denotes a scan speed.

Preferably, the module M2 is configured to perform following steps:
setting the filling scan parameters as P_{filling} and V_{filling}, the contour scan parameters as P_{contour} and V_{contour}, and a number of contour scans as PT; and calculating a contour parameter as follows:

$$\frac{{P}_{contour}}{{V}_{contour}} = \frac{{P}_{filling}}{{V}_{filling}} * ( 1 - \frac{PT}{Z} )$$

where, Z denotes a contour line energy density scaling coefficient, Z=5 to 30; within a range of a contour compensation value PC, the plurality of pre-contour scans and the plurality of post-contour scans are performed, from an inner contour scan to an outer contour scan or from an outer contour scan to an inner contour scan in terms of scan sequence; the pre-contour scans and the post-contour scans are performed by taking different values of following parameters: laser power P, scan speed V, number of contour scans PT, contour line energy density scaling coefficient Z, and contour compensation value PC; and a filling compensation value FC ranges within 0≤FC≤PC.

Preferably, the module M3 is configured to perform following steps:
acquiring a melt pool width corresponding to a structure and a process parameter, and optimizing the spot compensation value;
denoting a wall thickness/strut diameter of an original design scaffold model as T₀ and a wall thickness/strut diameter acquired by using the optimized contour scan strategy as T₁, and calculating the spot compensation value as follows:

$$SC = \frac{( {T}_{1} - {T}_{0} ) * SZ}{2 {R}_{melt}}$$

where, SZ denotes a spot diameter; Rₘₑₗₜ denotes the melt pool width corresponding to P_{filling}/V_{filling}; and the spot compensation value is adjustable to compensate for a dimensional increase caused by the plurality of contour scans.

Preferably, the module M1 is further configured to perform following steps: setting, before the filling scan is performed, the plurality of pre-contour scans with a predetermined energy density according to a specific scaffold structure and a length of a lower surface overhanging region; and setting, after the filling scan is completed, the plurality of post-contour scans with a predetermined energy density according to a specific surface powder adhesion condition of the scaffold.

Compared with the prior art, the present disclosure has the following beneficial effects:
1. The present disclosure in-situ eliminates powder adhesion and sagging defects inside the complex porous structure that severely affect inner surface roughness and scaffold performance during preparation. Therefore, the present disclosure improves the permeability, fatigue performance, and corrosion resistance of the porous scaffold. Additionally, the present disclosure simplifies cumbersome post-processing procedures, reduces production costs, and achieves green production.
2. The present disclosure greatly expands the maximum printable dimension of porous scaffolds, reduces the printable minimum wall thickness/strut diameter and pore size, and increases the freedom of structural design. Therefore, the present disclosure provides a brand new preparation method for magnesium alloy porous scaffolds with small pore sizes for large-segment bone defects. Meanwhile, the present disclosure controls wall thickness/strut diameter through a spot compensation strategy based on the melt pool dimension of specific structures. This eliminates the negative effects of the plurality of contour scans and avoids dimensional deviation from the model.

Other beneficial effects of the present disclosure will be elaborated in the Detailed Description of the Embodiments through specific technical features and technical solutions. Those skilled in the art should be able to appreciate the beneficial technical effects brought by these technical features and technical solutions.

### BRIEF DESCRIPTION OF THE DRAWINGS

Other features, objectives, and advantages of the present disclosure will become more apparent by reading the detailed description of non-limiting embodiments with reference to the following drawings.

FIG. 1 is a flowchart of a method in the present disclosure;

FIG. 2 is a schematic diagram of a relationship among spot compensation, contour compensation, and filling compensation;

FIG. 3 is a schematic diagram of a stair-stepping effect in LPBF slicing and the formation of sagging in an overhanging region in the present disclosure;

FIGS. 4A-4B are optical photographs of a scaffold top before and after optimization in the present disclosure; and

FIGS. 5A-5B are computed tomography (CT) scan results of a cross-section of scaffold overhanging region before and after optimizing a contour scan strategy in the present disclosure.

### DETAILED DESCRIPTION OF THE EMBODIMENTS

The present disclosure is described in detail below with reference to specific embodiments. The following embodiments will help those skilled in the art to further understand the present disclosure, but do not limit the present disclosure in any way. It should be noted that several variations and improvements can also be made by a person of ordinary skill in the art without departing from the conception of the present disclosure. These all fall within the protection scope of the present disclosure.

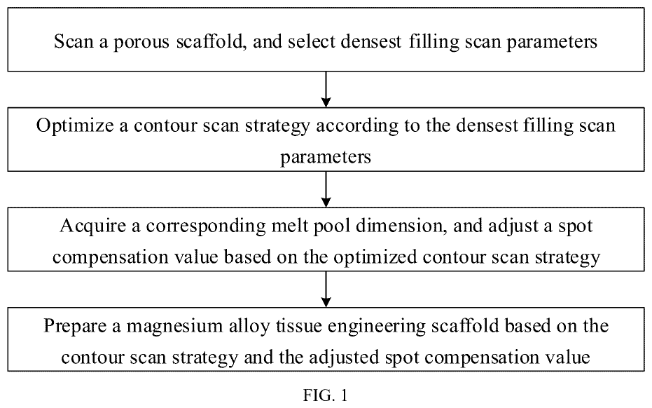

As shown in FIG. 1, a method for preparing a magnesium alloy tissue engineering scaffold with a smooth inner surface by LPBF includes following steps.

Step 1. A single-pass contour scan and a single-pass filling scan are performed to acquire densest filling scan parameters.

The single-pass contour scan and the single-pass filling scan are performed on a porous scaffold. Contour scan parameters are consistent with filling scan parameters. An as-built specimen is cut along a direction parallel to a build direction (BD), and a cross-section is polished. An optical micrograph of the cross-section is acquired, and a density of the cross-section is analyzed. Parameters satisfying 0.05≤P/V≤0.5 are selected from a parameter combination corresponding to a density of greater than 99.5%, where P is laser power in W, and V is scan speed in mm/s. A smaller V reduces powder spattering, and a smaller P provides a smaller melt pool dimension for higher precision. These two parameters are set as P_{filling} and V_{filling}.

Step 2. A contour scan strategy with minimal powder adhesion, a number of pre-contour scans, a number of post-contour scans, a contour offset value, and a filling offset value are determined.

The filling scan parameters are set as P_{filling} and V_{filling}. The contour scan parameters are set as P_{contour} and V_{contour}. The number of contour scans is set as PT (0≤PT≤15).

$$\frac{{P}_{contour}}{{V}_{contour}} = \frac{{P}_{filling}}{{V}_{filling}} * ( 1 - \frac{PT}{Z} )$$

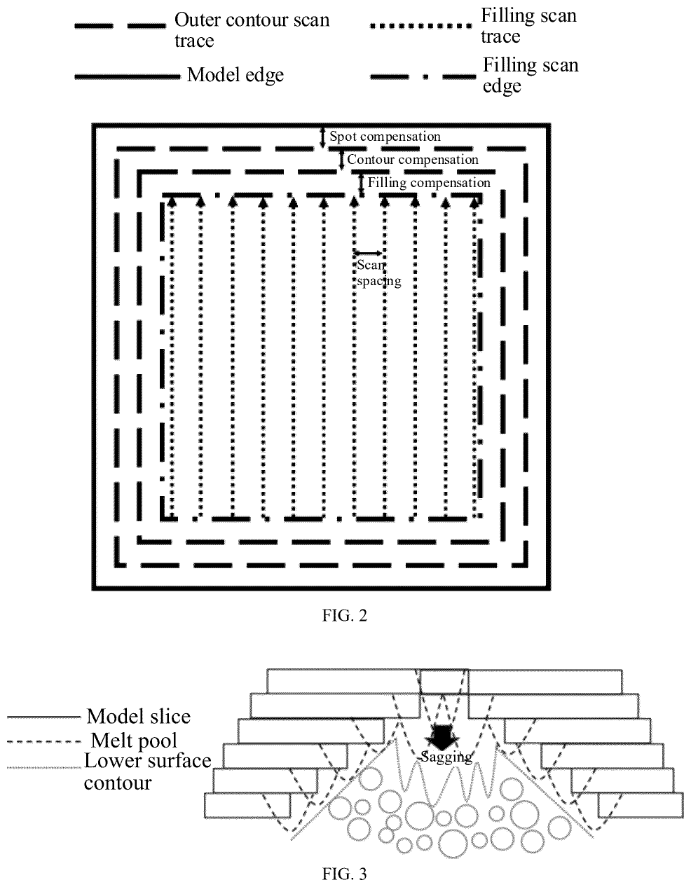

The contour scan parameters are determined through the above equation. A contour line energy density scaling coefficient is denoted as Z=5 to 30. The Z value depends on the specific scaffold structure, powder state, filling scan process, etc. For example, when Z=10 and PT=2, P_{contour}/V_{contour}=0.8*P_{filling}/V_{filling}. A contour compensation value is expressed as PC=(0 to 2)*Sₘₐₓ, where Sₘₐₓ denotes a maximum powder particle size. That is, the outer contour scan should melt adhered or agglomerated powder. As shown in FIG. 2, within the range of the contour compensation value, the plurality of pre-contour scans (edge scans performed before the filling scan) and the plurality of post-contour scans (edge scans performed after the filling scan) are performed. In terms of scan sequence, inner contour scan transitions gradually to outer contour scan, or outer contour scan transitions gradually to inner contour scan. Pre-contour scans and post-contour scans can be performed with different parameters of P, V, PT, Z, PC. The filling compensation value FC ranges within 0≤FC≤PC, depending on the strut diameter/wall thickness of the prepared scaffold, contour scan power/speed, and number of contour scans PT.

Before the filling scan is performed, the plurality of low-energy-density pre-contour scans are set according to the specific scaffold structure and a length of a lower surface overhanging region to effectively eliminate sagging on the lower surface.

The porous scaffold inevitably has a lower surface internally. Due to the “stair-stepping effect” in model slicing, a model slice edge includes an overhanging region of a predetermined length, as shown in FIG. 3. At a specific layer thickness reaching a critical overhang angle (a support angle is required, generally) 45°, the length of the overhanging region of the slice increases. This causes the length of a laser spot acting on the overhanging region to increase, ultimately expanding the interaction area between the laser and the powder below. The powder has higher laser absorptivity than the solidified structure and lower thermal conductivity than the solidified structure. Therefore, the actual heat accumulation in the overhanging region is excessive, causing the melt pool dimension to increase. Due to the lack of support below, the melt pool flows into the powder under gravity, capillary action, and low viscosity of the liquid metal. After solidification, the formed shape is highly irregular, forming a sagging defect on the lower surface. Sagging formation is mainly the result of excessive local energy input. To avoid sagging on the overhang, the melt pool volume is reduced by lowering the energy input of pre-contour scans. However, excessively low energy input can cause a lack-of-fusion defect. Therefore, the number of contour scans is increased to increase actual energy input and eliminate lack-of-fusion defect. During contour scans after the first one, the laser spot acts on the solidified structure. Therefore, the melt pool does not become too large, ultimately avoiding sagging. Specific pre-contour compensation value PCₚᵣₑ and number of pre-contour scans PTₚᵣₑ depend on the overhang angle of the lower surface region after model slicing and the unsupported length between layers of the slice. When the overhang angle is small and the unsupported length is long, the solidified zone of the previous layer provides less support to the melt pool at the model edge. In this case, larger contour compensation value PC is needed to make the first contour scan act on the solidified structure of the previous layer. The energy input and melt pool dimension are reduced through smaller P_{contour}/V_{contour}, and the edge region is densified through more contour scans PT, ultimately avoiding sagging on the lower surface contour of the prepared scaffold.

After the filling scan is completed, the plurality of low-energy-density post-contour scans are set according to the specific surface powder adhesion on the scaffold to effectively eliminate surface powder adhesion.

The incompletely melted powder particles adhered to a top and a side of a strut after the filling scan is re-melted through outward-expanding post-contour scans. This process melts the powder adhered to the strut surface into part of the strut diameter, which reduces the strut surface roughness but increases the strut wall thickness. The LPBF process has a unique denudation phenomenon. In a powder-free region along the scan path, inward airflow caused by surface tension and melt pool evaporation draws surrounding powder particles into the melt pool, which is called denudation. After the filling scan, there is less powder around the strut. The outward-offset contour scan does not melt new powder. Specific contour compensation value PCpost and number of post-contour scans PTₚₒₛₜ depend on the powder particle size and the amount of adhered powder. If the adhered powder has a larger particle size, a larger offset distance is needed for the spot to act better on the powder. If more powder is adhered, more scans are needed to melt the powder into part of the matrix. Therefore, the low-energy-density post-contour scan strategy can eliminate surface powder adhesion and reduce surface roughness.

Step 3. A melt pool width corresponding to the structure and process parameters is acquired, and a spot compensation value is optimized accordingly.

The wall thickness/strut diameter of the original design scaffold model is denoted as T₀, and the wall thickness/strut diameter acquired by using the optimized contour scan strategy is denoted as T₁. Therefore, the spot compensation value is:

$$SC = \frac{( {T}_{1} - {T}_{0} ) * SZ}{2 {R}_{melt}}$$

SZ denotes a spot diameter. Rₘₑₗₜ denotes the melt pool width corresponding to P_{filling}/V filling (acquired by observing the metallographic longitudinal section after cold mounting). The dimensional increase caused by the plurality of contour scans is compensated by adjusting the spot compensation value. For example, when T₀=750 μm and T₁=1,000 μm, (T₁−T₀)/2=125 μm. When SZ=40 μm, Rₘₑₗₜ=100 μm, and Rₘₑₗₜ/SZ=2.5:

$$SC = \frac{[ \frac{{T}_{1} - {T}_{0}}{2} ]}{( \frac{{R}_{melt}}{SZ} )} = 50 μm$$

That is, when the spot compensation value SC=50 μm, the target strut diameter/wall thickness is acquired.

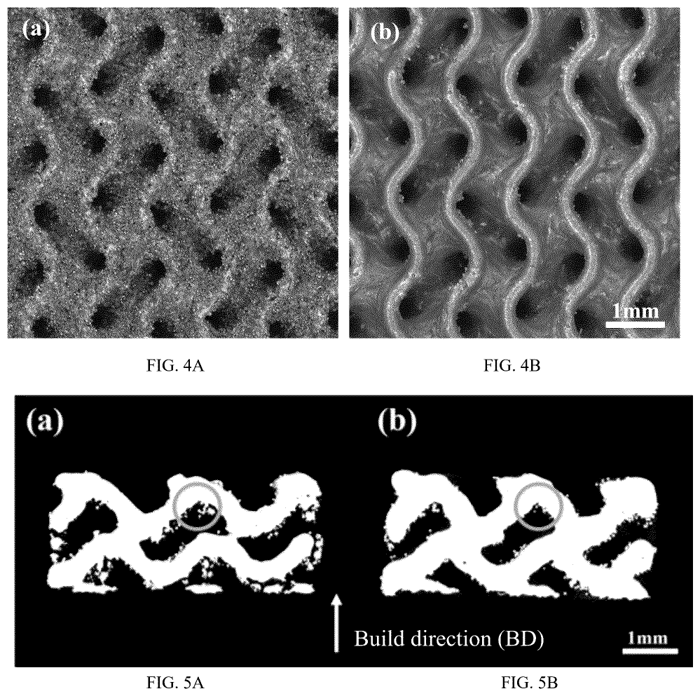

As shown in FIGS. 4A-4B, FIG. 4A shows the morphology of the scaffold top before optimization using the method of the present disclosure, while FIG. 4B shows the morphology of the scaffold top after optimization using the method of the present disclosure. After the pre-contour and post-contour scan strategies are optimized, the spot compensation value is adjusted based on the melt pool dimension in the filling scan region under specific structures and process parameters. This effectively reduces the difference between the scaffold wall thickness and the design value.

As shown in FIGS. 5A-5B, FIG. 5A shows a CT result of the cross-section of the scaffold overhanging region with sagging before optimization using the method of the present disclosure, while FIG. 5B shows a CT result of the cross-section of the scaffold overhanging region after optimization using the method of the present disclosure. After the powder adhered to the scaffold edge is re-melted into part of the matrix, the wall thickness/strut diameter increases to some extent. Therefore, it is necessary to set a spot compensation value during slicing to ensure the wall thickness/strut diameter of the printed scaffold is close to the design value. The melt pool dimension is correlated with the structure. A thinner wall leads to a lower vertical thermal conductivity and a larger melt pool dimension. Therefore, it is necessary to adjust the spot compensation value specifically according to the melt pool dimension of different structures. (T₁−T₀) is the reduction value of the wall thickness/strut diameter. 2*(Rₘₑₗₜ/SZ) is the reduction value of the wall thickness when the spot center moves inward per unit distance under the parameter. Dividing the former by the latter gives the spot compensation value.

Step 4. A magnesium alloy tissue engineering scaffold with a wall thickness consistent with a design value, a smooth inner surface, and a dense interior is prepared based on the optimized contour scan strategy and spot compensation value.

The above is the basic embodiment of the present disclosure. The technical solution of the present disclosure is further explained below through three preferred embodiments.

### Embodiment 1

### Preparation of Minimal Surface Magnesium Scaffold

This embodiment relates to a degradable magnesium alloy tissue engineering scaffold for bone defect repair. A minimal surface scaffold model with G-type unit cells is designed using relevant modeling software according to following parameters: scaffold diameter D=5 mm, height H=7 mm, unit cell dimension U=2 mm, model wall thickness T₀=180 μm, and porosity≈75%.

This embodiment relates to the method for preparing a high-precision magnesium alloy tissue engineering scaffold with a smooth inner surface by LPBF, including the following steps.

Step 1. A single-pass pre-contour scan and a single-pass filling scan are performed to acquire densest filling scan parameters.

The 3D structural model of the scaffold is imported into Materialise Mimics software for slicing. Sliced data are imported into a 3D printing device. Layer-by-layer printing is performed using a ProX DMP 320 metal 3D printer from 3D SYSTEMS, an American company. The printing uses 99.99% high-purity degradable medical magnesium powder, which is smooth and regularly spherical, and has a particle size of 50-90 μm, following a normal distribution, S_{avg}=70 μm. Before printing starts, the internal chamber of the 3D printer is repeatedly evacuated and filled with inert gas three times until the oxygen content in the internal chamber drops below 30 ppm. The printing parameters are set as follows: spot diameter SZ=80 μm, layer thickness LT=20 μm, filling spacing HS=80 μm, interlayer rotation scanning angle=67°, contour compensation value PC-0 μm, and filling compensation value FC=40 μm. A process window is tried in units of 100 mm/s and 10 W. The cross-section of the acquired specimen is mechanically polished. A metallographic image of the cross-section is acquired, and the density of the specimen is calculated (as shown in Table 1). Parameters corresponding to a density >99.5% are selected, namely P_{filling}-80 W, V_{filling}=500 mm/s. The scaffold top corresponding to these parameters is shown in FIG. 4A.

Step 2. A contour scan strategy with minimal powder adhesion, a number of pre-contour scans increased, a number of post-contour scans increased, a contour offset value, and a filling offset value are determined.

The number of contour scans is set as PT=6, where the number of pre-contour scans is set as PTₚᵣₑ=2, and the number of post-contour scans is set as PTₚₒₛₜ=4. When Z=20, P_{contour}/V_{contour} (1-6/20)*P_{filling}/V_{filling}. When V_{filling}=V_{contour}=500 mm/s, P_{contour}=0.7*P_{filling}=56 W. The contour compensation value is PC=40 μm, and the filling compensation value is FC=40 μm. The pre-contour scan includes two inner contour scans, and the post-contour scan includes two inner contour scans, followed by two outer contour scans.

Step 3. A melt pool width corresponding to the structure and process parameters is acquired, and a spot compensation value is optimized accordingly.

The wall thickness of the scaffold prepared with these contour parameters is T₁₌₂₆₀ μm. The melt pool width for the filling scan is calculated as Rₘₑₗₜ=140 μm through grinding. Therefore, the spot compensation value is SC=[(260-180)*80]/(2*140)=22.86 μm.

Step 4. A magnesium alloy tissue engineering scaffold with a wall thickness consistent with a design value, a smooth surface, and a dense interior is prepared based on the optimized contour scan strategy and spot compensation value.

The optimized specimen preparation parameters include: spot compensation value SC=32 μm, contour compensation value PC-filling compensation value FC=40 μm, number of pre-contour scans PTₚᵣₑ=2, number of post-contour scans PTₚₒₛₜ=4, P_{contour}=56 W, V_{contour}=500 mm/s, P_{filling}=80 W, and V_{filling}=500 mm/s. Through re-printing, a minimal surface magnesium scaffold with a wall thickness of 180 μm and a smooth surface is acquired. The optimized scaffold top is shown in FIG. 4B. The resulting scaffold has good structural reproducibility, and its surface has a bright metallic luster.

TABLE 1
Different scaffold densities corresponding
to different laser powers and scan speeds

| | 50 W | 60 W | 70 W | 80 W | 90 W |
|---|---|---|---|---|---|
| 700 mm/s | 90.70% | 92.52% | 95.86% | 97.94% | 98.86% |
| 600 mm/s | 91.62% | 94.93% | 97.73% | 99.16% | 99.52% |
| 500 mm/s | 92.71% | 95.52% | 98.97% | 99.66% | 99.69% |
| 400 mm/s | 93.63% | 97.64% | 99.58% | 99.87% | 99.85% |
| 300 mm/s | 94.52% | 98.99% | 99.82% | 99.92% | 99.98% |
| 200 mm/s | 95.66% | 99.53% | 99.73% | 99.87% | 99.88% |

### Embodiment 2

### Preparation of Low Porosity EK30 Magnesium Alloy Tissue Engineering Scaffold

This embodiment relates to a degradable gradient scaffold for large-segment bone defect repair. A minimal surface scaffold model with G-type unit cells is designed using relevant modeling software according to following parameters: scaffold diameter D=5 mm, height H=3 mm, unit cell dimension U=2 mm, model wall thickness T₀=450 μm, and porosity≈50%.

This embodiment relates to the method for preparing a high-precision magnesium alloy scaffold with a smooth inner surface by LPBF, including the following steps.

Step 1. A filling scan and a single-pass post-contour scan are performed to acquire densest filling scan parameters.

The 3D structural model of the scaffold is imported into Materialise Mimics software for slicing. Sliced data are imported into a 3D printing device. Layer-by-layer printing is performed using a ProX DMP 320 metal 3D printer from 3D SYSTEMS, an American company. The printing uses degradable medical magnesium alloy powder Mg-3 wt. % Nd-0.18 wt. % Zn-0.45 wt. % Zr, which is smooth and regularly spherical, and has a particle size of 20-50 μm and S_{avg}=35 μm. Before printing starts, the internal chamber of the 3D printer is repeatedly evacuated and filled with inert gas three times until the oxygen content in the internal chamber drops below 30 ppm. The printing parameters are set as follows: spot diameter SZ=60 μm, layer thickness LT=10 μm, filling spacing HS=100 μm, interlayer rotation scanning angle=67°, contour compensation value PC=0 μm, and filling compensation value FC=40 μm. A process window is tried in units of 100 mm/s and 10 W. The cross-section of the acquired specimen is mechanically polished. A metallographic image of the cross-section is acquired, and the density of the specimen is calculated. Parameters corresponding to a density >99.5% are selected, namely P_{filling}=60 W, V_{filling}=600 mm/s.

Step 2. A contour scan strategy with minimal powder adhesion, a number of pre-contour scans increased, a number of post-contour scans increased, a contour offset value, and a filling offset value are determined.

The number of contour scans is set as PT=8, where the number of pre-contour scans is set as PTₚᵣₑ-4, and the number of post-contour scans is set as PTₚₒₛₜ=4. When Z=24, P_{contour}/V_{contour}=(1-8/24)*P_{filling}/V_{filling}. When V_{filling}=V_{contour}=600 mm/s, P_{contour}=2/3*P_{filling}=40 W. The contour compensation value is PC=20 μm, and the filling compensation value is FC=20 μm. The pre-contour scan includes two outer contour scans, followed by two inner contour scans, and the post-contour scan includes two inner contour scans, followed by two outer contour scans.

Step 3. A melt pool width corresponding to the structure and process parameters is acquired, and a spot compensation value is optimized accordingly.

The wall thickness of the scaffold prepared with these contour parameters is T₁=500 μm. The melt pool width for the filling scan is calculated as Rₘₑₗₜ-80 μm through grinding. Therefore, the spot compensation value is SC=[(500-450)*60]/(2*80)=18.75 μm.

Step 4. A magnesium alloy tissue engineering scaffold with a wall thickness consistent with a design value, a smooth surface, and a dense interior is prepared based on the optimized contour scan strategy and spot compensation value.

The optimized specimen preparation parameters include: spot compensation value SC=18.75 μm, contour compensation value PC=filling compensation value FC-20 μm, number of pre-contour scans PTₚᵣₑ=4, number of post-contour scans PTₚₒₛₜ=4, P_{contour}=40 W, V_{contour}=600 mm/s, P_{filling}=60 W, and V_{filling}-600 mm/s. Through re-printing, a minimal surface magnesium scaffold with a wall thickness of 450 μm and a sagging-free overhanging region is acquired. FIGS. 5A-5B show the cross-sections of the scaffold overhanging region before and after optimization of the contour scan strategy.

### Embodiment 3

### Preparation of Diamond Structure WE43 Magnesium Alloy Tissue Engineering Scaffold

This embodiment relates to a degradable gradient scaffold for large-segment bone defect repair. A rod-shaped diamond structure scaffold model is designed using relevant modeling software according to following parameters: scaffold diameter D=10 mm, height H=15 mm, unit cell dimension U=1.2 mm, model strut diameter T₀=760 μm, and porosity≈60%.

This embodiment relates to the method for preparing a high-precision magnesium alloy tissue engineering scaffold with a smooth inner surface by LPBF, including the following steps.

Step 1. A single-pass pre-contour scan and a single-pass filling scan are performed to acquire densest filling scan parameters.

The 3D structural model of the scaffold is imported into Materialise Mimics software for slicing. Sliced data are imported into a 3D printing device. Layer-by-layer printing is performed using a ProX DMP 320 metal 3D printer from 3D SYSTEMS, an American company. The printing uses 99.99% WE43 commercial magnesium alloy powder, which is smooth and regularly spherical, and has a particle size of 40-80 μm, following a normal distribution, S_{avg}=60 μm. Before printing starts, the internal chamber of the 3D printer is repeatedly evacuated and filled with inert gas three times until the oxygen content in the internal chamber drops below 30 ppm. The printing parameters are set as follows: spot diameter SZ=70 μm, layer thickness LT=30 μm, filling spacing HS=120 μm, interlayer rotation scanning angle=67°, contour compensation value PC-0 μm, and filling compensation value FC=30 μm. A process window is tried in units of 100 mm/s and 10 W. The cross-section of the acquired specimen is mechanically polished. A metallographic image of the cross-section is acquired, and the density of the specimen is calculated. Parameters corresponding to a density >99.5% are selected, namely P_{filling}=90 W, V_{filling}=500 mm/s.

Step 2. A contour scan strategy with minimal powder adhesion, a number of pre-contour scans increased, a number of post-contour scans increased, a contour offset value, and a filling offset value are determined. The number of contour scans is set as PT=7, where the number of pre-contour scans is set as PTₚᵣₑ=1, and the number of post-contour scans is set as PTₚₒₛₜ=6. When Z=21, P_{contour}/V_{contour}=(1-7/21)*P_{filling}/V_{filling}. When V_{filling}=V_{contour}=500 mm/s, P_{contour}=2/3*P_{filling}=60 W. The contour compensation value is PC=30 μm, and the filling compensation value is FC-30 μm. The pre-contour scan includes one inner contour scan, and the post-contour scan includes three outer contour scans, followed by three inner contour scans.

Step 3. A melt pool width corresponding to the structure and process parameters is acquired, and a spot compensation value is optimized accordingly. The strut diameter of the scaffold prepared with these contour parameters is T₁₌₉₂₀ μm. The melt pool width for the filling scan is calculated as Rₘₑₗₜ=130 μm through grinding. Therefore, the spot compensation value is SC=[(920-760)*70]/(2*130)=43.08 μm.

Step 4. A magnesium alloy tissue engineering scaffold with a wall thickness consistent with a design value, a smooth surface, and a dense interior is prepared based on the optimized contour scan strategy and spot compensation value. The optimized specimen preparation parameters include: spot compensation value SC=43.08 μm, contour compensation value PC=filling compensation value FC-30 μm, number of pre-contour scans PTₚᵣₑ=1, number of post-contour scans PTₚₒₛₜ=6, P_{contour}=40 W, V_{contour}=600 mm/s, P_{filling}=90 W, and V_{filling}=500 mm/s. Through re-printing, a diamond structure WE43 magnesium alloy tissue engineering scaffold with a strut diameter of 760 μm and a sagging-free overhanging region is acquired.

In summary, the present disclosure has the following advantages. The present disclosure can in-situ eliminate powder adhesion and sagging defects inside complex porous structures that severely affect inner surface roughness and scaffold performance during preparation. Therefore, the present disclosure improves the permeability, fatigue performance, and corrosion resistance of porous scaffolds. The present disclosure simplifies cumbersome post-processing procedures, reduces production costs, and achieves green production. The present disclosure greatly expands the maximum printable dimension of porous scaffolds, reduces the printable minimum wall thickness/strut diameter and pore size, and increases the freedom of structural design. Therefore, the present disclosure provides a brand new preparation method for magnesium alloy porous scaffolds with small pore sizes for large-segment bone defects. Meanwhile, the present disclosure controls wall thickness/strut diameter through a spot compensation strategy based on the melt pool dimension of specific structures. This eliminates the negative effects of the plurality of contour scans and avoids dimensional deviation from the model.

The present disclosure further provides a method for preparing a magnesium alloy tissue engineering scaffold with a smooth inner surface by LPBF. The method for preparing a magnesium alloy tissue engineering scaffold with a smooth inner surface by LPBF can be implemented by executing the process steps of the method for preparing a magnesium alloy tissue engineering scaffold with a smooth inner surface by LPBF. That is, those skilled in the art can consider the method for preparing a magnesium alloy tissue engineering scaffold with a smooth inner surface by LPBF as a preferred implementation of the method for preparing a magnesium alloy tissue engineering scaffold with a smooth inner surface by LPBF.

Specifically, the method for preparing a magnesium alloy tissue engineering scaffold with a smooth inner surface by LPBF includes: module M1, module M2, module M3, and module M4.

The module M1 is configured to scan a porous scaffold and select densest filling scan parameters.

The scan includes a single-pass contour scan and a single-pass filling scan.

The module M2 is configured to optimize the contour scan strategy according to the densest filling scan parameters.

The module M3 is configured to acquire the corresponding melt pool dimension and adjust the spot compensation value based on the optimized contour scan strategy.

The module M4 is configured to prepare the magnesium alloy tissue engineering scaffold based on the contour scan strategy and the adjusted spot compensation value.

The function of module M1 is described as follows.

A single-pass contour scan and a single-pass filling scan are performed on the porous scaffold. Contour scan parameters are consistent with filling scan parameters. An as-built specimen is cut along a direction parallel to a BD, and a cross-section is polished. An optical micrograph of the cross-section is acquired, and a density of the cross-section is analyzed. Parameters satisfying 0.05≤P/V≤0.5 are selected from a parameter combination with a density of greater than 99.5%.

P denotes a laser power, and V denotes a scan speed.

The function of module M2 is described as follows.

Fill scan parameters are set as P_{filling} and V_{filling}, contour scan parameters are set as P_{contour} and V_{contour}, the number of contour scans is set as PT, and the contour parameters are calculated as follows:

$$\frac{{P}_{contour}}{{V}_{contour}} = \frac{{P}_{filling}}{{V}_{filling}} * ( 1 - \frac{PT}{Z} )$$

The contour line energy density scaling coefficient is Z=5 to 30. Within the range of the contour compensation value, the plurality of pre-contour scans and the plurality of post-contour scans are performed. In terms of scan sequence, inner contour scan transitions to outer contour scan, or outer contour scan transitions to inner contour scan. The pre-contour scans and post-contour scans can adopt different parameters: laser power P, scan speed V, number of contour scans PT, contour line energy density scaling coefficient Z, and contour compensation value PC. The filling compensation value FC ranges within 0≤FC≤PC.

The function of module M3 is described as follows.

A melt pool width corresponding to the structure and process parameters is acquired, and a spot compensation value is optimized.

The wall thickness/strut diameter of the original design scaffold model is denoted as T₀, and the wall thickness/strut diameter acquired by using the optimized contour scan strategy is denoted as T₁. Therefore, the spot compensation value is:

$$SC = \frac{( {T}_{1} - {T}_{0} ) * SZ}{2 {R}_{melt}}$$

SZ denotes a spot diameter. Rₘₑₗₜ denotes the melt pool width corresponding to P_{filling}/V_{filling}. By adjusting the spot compensation value, the dimensional increase caused by the plurality of contour scans is compensated.

The module M1 also has the following functions. Before the filling scan is performed, the plurality of pre-contour scans with a predetermined energy density are set according to the specific scaffold structure and the length of the lower surface overhanging region. After the filling scan is completed, the plurality of post-contour scans with a predetermined energy density are set according to the specific surface powder adhesion condition of the scaffold.

Those skilled in the art are aware that in addition to being realized by using pure computer-readable program code, the method and each apparatus, module, and unit thereof provided in the present disclosure can realize a same program in a form of a logic gate, a switch, an application-specific integrated circuit, a programmable logic controller, or an embedded microcontroller by performing logic programming on the method steps. Therefore, the method and each apparatus, module, and unit thereof provided in the present disclosure can be regarded as a kind of hardware component. The apparatus, module, and unit included therein for realizing each function can also be regarded as a structure in the hardware component; and the apparatus, module, and unit for realizing each function can also be regarded as a software module for implementing the method or a structure in the hardware component.

In the description of the present disclosure, it needs to be understood the orientation or positional relationships indicated by terms, such as “up”, “down”, “front”, “rear”, “left”, “right”, “vertical”, “horizontal”, “top”, “bottom”, “inside”, and “outside”, are based on the orientation or positional relationship shown in the drawings, are merely for facilitating the description of the present disclosure and simplifying the description, rather than indicating or implying that an apparatus or element referred to must have a particular orientation or be constructed and operated in a particular orientation, and therefore shall not be interpreted as limiting the present disclosure.

The specific embodiments of the present disclosure are described above. It should be understood that the present disclosure is not limited to the above specific implementations, and a person skilled in the art can make various variations or modifications within the scope of the claims without affecting the essence of the present disclosure. The embodiments of the present disclosure and features in the embodiments may be arbitrarily combined with each other in a non-conflicting situation.

What is claimed is:

1. A method for preparing a magnesium alloy tissue engineering scaffold with a smooth inner surface by laser powder bed fusion (LPBF), comprising:
step S1: scanning a porous scaffold, and selecting densest filling scan parameters;
wherein the scanning comprises a single-pass contour scan and a single-pass filling scan;
step S2: optimizing a contour scan strategy according to the densest filling scan parameters to obtain an optimized contour scan strategy;
step S3: acquiring a corresponding melt pool dimension, and adjusting a spot compensation value based on the optimized contour scan strategy to obtain an adjusted spot compensation value; and
step S4: preparing the magnesium alloy tissue engineering scaffold based on the optimized contour scan strategy and the adjusted spot compensation value.

2. The method according to claim 1, wherein the step S1 comprises:
performing the single-pass contour scan and the single-pass filling scan on the porous scaffold, with contour scan parameters consistent with filling scan parameters; cutting an as-built specimen along a direction parallel to a build direction (BD); polishing a cross-section, acquiring an optical micrograph of the cross-section, and analyzing a density of the cross-section; and selecting the filling scan parameters P_{filling} and V_{filling} satisfying 0.05≤P/V≤0.5 from a parameter combination corresponding to the density of the cross-section of greater than 99.5%;
wherein P denotes a laser power, and V denotes a scan speed.

3. The method according to claim 2, wherein the step S2 comprises:
setting the filling scan parameters as P_{filling} and V_{filling}, the contour scan parameters as P_{contour} and V_{contour}, and a number of contour scans as PT; and calculating a contour parameter as follows:
$$\frac{{P}_{contour}}{{V}_{contour}} = \frac{{P}_{filling}}{{V}_{filling}} * ( 1 - \frac{PT}{Z} )$$
wherein Z denotes a contour line energy density scaling coefficient, Z=5 to 30; within a range of a contour compensation value PC, a plurality of pre-contour scans and a plurality of post-contour scans are performed, from an inner contour scan to an outer contour scan or from the outer contour scan to the inner contour scan in terms of scan sequence; the plurality of pre-contour scans and the plurality of post-contour scans are performed by taking different values of the following parameters: the laser power P, the scan speed V, the number of the contour scans PT, the contour line energy density scaling coefficient Z, and the contour compensation value PC; and a filling compensation value FC ranges within 0≤FC≤PC.

4. The method according to claim 3, wherein the step S3 comprises:
acquiring a melt pool width corresponding to a structure of the porous scaffold and a process parameter, and optimizing the spot compensation value; and
denoting a wall thickness/strut diameter of an original design scaffold model as T₀ and a wall thickness/strut diameter acquired by using the optimized contour scan strategy as T₁, and calculating the spot compensation value as follows:
$$SC = \frac{( {T}_{1} - {T}_{0} ) * SZ}{2 {R}_{melt}}$$
wherein SZ denotes a spot diameter; Rₘₑₗₜ denotes the melt pool width corresponding to P_{filling}/V_{filling}; and the spot compensation value is adjustable to compensate for a dimensional increase caused by a plurality of contour scans.

5. The method according to claim 2, wherein the step S1 further comprises: setting, before the single-pass filling scan is performed, a plurality of pre-contour scans with a first predetermined energy density according to a structure of the porous scaffold and a length of a lower surface overhanging region; and setting, after the single-pass filling scan is completed, a plurality of post-contour scans with a second predetermined energy density according to a surface powder adhesion condition of the porous scaffold.

6. A method for preparing a magnesium alloy tissue engineering scaffold with a smooth inner surface by LPBF, comprising:
a module M1, configured to scan a porous scaffold and select densest filling scan parameters;
wherein the scan comprises a single-pass contour scan and a single-pass filling scan;
a module M2, configured to optimize a contour scan strategy according to the densest filling scan parameters to obtain an optimized contour scan strategy;
a module M3, configured to acquire a corresponding melt pool dimension and adjust a spot compensation value based on the optimized contour scan strategy to obtain an adjusted spot compensation value; and
a module M4, configured to prepare the magnesium alloy tissue engineering scaffold based on the optimized contour scan strategy and the adjusted spot compensation value.

7. The method according to claim 6, wherein the module M1 is configured to perform the following steps:
performing the single-pass contour scan and the single-pass filling scan on the porous scaffold, with contour scan parameters consistent with filling scan parameters; cutting an as-built specimen along a direction parallel to a BD; polishing a cross-section, acquiring an optical micrograph of the cross-section, and analyzing a density of the cross-section; and selecting the filling scan parameters P_{filling} and V_{filling} satisfying 0.05≤P/V≤0.5 from a parameter combination corresponding to the density of the cross-section of greater than 99.5%;
wherein P denotes a laser power, and V denotes a scan speed.

8. The method according to claim 7, wherein the module M2 is configured to perform the following steps:
setting the filling scan parameters as P_{filling} and V_{filling}, the contour scan parameters as P_{contour} and V_{contour}, and a number of contour scans as PT; and calculating a contour parameter as follows:
$$\frac{{P}_{contour}}{{V}_{contour}} = \frac{{P}_{filling}}{{V}_{filling}} * ( 1 - \frac{PT}{Z} )$$
wherein Z denotes a contour line energy density scaling coefficient, Z=5 to 30; within a range of a contour compensation value PC, a plurality of pre-contour scans and a plurality of post-contour scans are performed, from an inner contour scan to an outer contour scan or from the outer contour scan to the inner contour scan in terms of scan sequence; the plurality of pre-contour scans and the plurality of post-contour scans are performed by taking different values of the following parameters: the laser power P, the scan speed V, the number of the contour scans PT, the contour line energy density scaling coefficient Z, and the contour compensation value PC; and a filling compensation value FC ranges within 0≤FC≤PC.

9. The method according to claim 8, wherein the module M3 is configured to perform the following steps:
acquiring a melt pool width corresponding to a structure of the porous scaffold and a process parameter, and optimizing the spot compensation value; and
denoting a wall thickness/strut diameter of an original design scaffold model as T₀ and a wall thickness/strut diameter acquired by using the optimized contour scan strategy as T₁, and calculating the spot compensation value as follows:
$$SC = \frac{( {T}_{1} - {T}_{0} ) * SZ}{2 {R}_{melt}}$$
wherein SZ denotes a spot diameter; Rₘₑₗₜ denotes the melt pool width corresponding to P_{filling}/V_{filling}; and the spot compensation value is adjustable to compensate for a dimensional increase caused by a plurality of contour scans.

10. The method according to claim 7, wherein the module M1 is further configured to perform the following steps: setting, before the single-pass filling scan is performed, a plurality of pre-contour scans with a first predetermined energy density according to a structure of the porous scaffold and a length of a lower surface overhanging region; and setting, after the single-pass filling scan is completed, a plurality of post-contour scans with a second predetermined energy density according to a surface powder adhesion condition of the porous scaffold.
